(19) United States
(12) Patent Application Publication
(10) Pub. No.: US 2023/0347622 A1
(43) Pub. Date: Nov. 2, 2023

(54) BONDED ARTICLES AND METHODS FOR FORMING THE SAME

(71) Applicant: CORNING INCORPORATED, CORNING, NY (US)

(72) Inventors: Rocco Lafleur, Santa Barbara, CA (US); Stephan Lvovich Logunov, Corning, NY (US); Brian Nilsen, Goleta, CA (US); Mark Alejandro Quesada, Horseheads, NY (US); Thomas Mikio Wynne, Santa Barbara, CA (US)

(21) Appl. No.: 17/779,042

(22) PCT Filed: Nov. 12, 2020
(86) PCT No.: PCT/US2020/060084

§ 371 Date: May 23, 2022

Related U.S. Application Data
(60) Provisional application No. 62/939,916, filed on Nov. 25, 2019.

(51) Int. Cl. B32B 7/14; G02B 3/12; G02B 26/00; B23K 26/20; B23K 26/211; B32B 37/12; B32B 38/00; B32B 37/24

(52) U.S. Cl. CPC B32B 7/14; G02B 3/12; G02B 26/005; B23K 26/206; B23K 26/211; B32B 37/1292; B32B 38/0008; B32B 37/24; B32B 2037/246; B32B 2250/02; B32B 2255/205; B32B 2255/28; B32B 2307/202; B32B 2310/0843; B32B 2309/105; B32B 2457/00; B32B 2551/00; C03C 27/08

(57) ABSTRACT

A bonded article includes a first substrate, a second substrate, and a bonding layer disposed between the first substrate and the second substrate. The bonding layer includes a conducting layer and a capping layer. The first substrate is bonded to the second substrate at a bonded region extending along a bond track. The bonded region is substantially continuous between the first substrate and the second substrate.

### CROSS REFERENCE TO RELATED APPLICATIONS

This application claims the benefit of priority under 35 U.S.C. § 119 of U.S. Provisional Application No. 62/939,916, filed Nov. 25, 2019, the content of which is incorporated herein by reference in its entirety.

### BACKGROUND

### Field

This disclosure relates to bonded articles and methods for forming bonded articles.

### Technical Background

Bonding of glass-to-glass substrates and other transparent and non-transparent substrates can be used for microfluidic applications, encapsulating organic electronic components (e.g., organic light emitting diodes), as well as other applications. Hermetic bonding can seal liquids or other components between the substrates. Laser bonding can provide electrically conductive and/or non-conductive hermetic bonding for various devices.

### SUMMARY

In some embodiments, a bonded article includes a first substrate, a second substrate, and a bonding layer disposed between the first substrate and the second substrate. The bonding layer can include a conducting layer and a capping layer, which can be disposed on the first substrate. The first substrate can be bonded to the second substrate at a bonded region extending along a bond track. The bonded region can be substantially continuous between the first substrate and the second substrate.

In some embodiments, the bonded region can seal a gap disposed between the first substrate and the second substrate, and the bonded region can be at least partially defined by the bond track. In some embodiments, the bonded region can be substantially free of voids.

In some embodiments, the capping layer of the bonding layer can be at least partially dispersed into the first substrate, the second substrate, or the first and the second substrates in the bonded region.

In some embodiments, each of the conducting layer and the capping layer of the bonding layer can be at least partially dispersed the first substrate, the second substrate, or the first and the second substrates in the bonded region.

In some embodiments, the bonding layer can be conductive across the bonded region. In some embodiments, a resistance of the bonding layer across the bonded region can be less than or equal to about 10 kΩ.

In some embodiments, the conducting layer can have a thickness of about 100 nm to about 200 nm, and the capping layer can have a thickness of about 25 nm to about 75 nm.

In some embodiments, the conducting layer can include a metal material, and the capping layer can include a metal oxide material. In some embodiments, the metal material of the conducting layer can be chromium, nickel, gold, silver, aluminum, tungsten, cobalt, iron, titanium, molybdenum, or a combination thereof, and the metal oxide material of the capping layer can be chromium oxynitride.

In some embodiments, a gap in the conducting layer can define a channel formed in the bonding layer, the capping layer can extend across the channel formed in the bonding layer, and the bond track can cross the channel in the bonding layer at an intersection. In some embodiments, the channel formed in the bonding layer can have a width of about 0.5 μm to about 20 μm.

In some embodiments, the bonding layer can be non-conductive across the channel. In some embodiments, a resistance of the bonding layer across the channel can be greater than or equal to about 10 MΩ.

In some embodiments, a method includes forming a patterned conducting layer on a first substrate, the patterned conducting layer including a gap formed therein, and forming a capping layer on the patterned conducting layer. The capping layer can extend across the gap in the patterned conducting layer. The patterned conducting layer and the capping layer can cooperatively define a bonding layer disposed on the first substrate. The bonding layer can include a channel defined by the gap in the conducting layer. The method can include positioning a second substrate on the bonding layer and irradiating the bonding layer with laser energy to bond the first substrate to the second substrate at a bonded region extending along a bond track that crosses the channel at an intersection. The bonded region can be substantially continuous across the intersection.

In some embodiments, the bonding layer can be non-conductive across the channel. In some embodiments, the method can include forming the patterned conducting layer comprising the gap having a width of about 0.5 μm to about 20 μm.

In some embodiments, the patterned conducting layer can have a thickness of about 100 nm to about 200 nm, and the capping layer can have a thickness of about 25 nm to about 75 nm.

In some embodiments, the patterned conducting layer can include a metal material, and the capping layer can include a metal oxide material.

In some embodiments, the method can include tuning the laser energy of a pulsed laser by a pulse energy, a focus, a marking speed, or a combination thereof. In some embodiments, the method can include tuning the laser energy of a continuous wave laser by a power density, exposure time, or a combination thereof.

Further features and advantages of the disclosure, as well as the structure and operation of various embodiments of the disclosure, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present disclosure and, together with the description, further serve to explain the principles of the disclosure and to enable a person skilled in the relevant art(s) to make and use the disclosure.

FIG. 1 is a schematic cross-sectional view of a liquid lens apparatus, according to some embodiments.

FIG. 2 is a schematic top plan view of the liquid lens apparatus of FIG. 1, according to some embodiments.

FIG. 3 is a schematic cross-sectional view of a laser bonding structure, according to some embodiments.

FIGS. 4A and 4B are exemplary scanning electron microscopy (SEM) cross-sectional views of bonded structures, according to some embodiments.

FIGS. 5A, 5B, and 5C are exemplary top plan views of bond lines with different laser bonding conditions, according to some embodiments.

FIGS. 6A and 6B are exemplary top plan view and cross-sectional view of a bonding structure with patterned gaps, according to some embodiments.

FIGS. 7A and 7B are exemplary SEM cross-sectional views of bonded structures with patterned gaps, according to some embodiments.

FIG. 8 is an exemplary top plan view of a bonded structure with patterned gaps, according to some embodiments.

FIG. 9 is a schematic top plan view of a calcium patch test structure with patterned gaps, according to some embodiments.

FIG. 10 is a flow chart illustrating a method to form a bonded structure with patterned gaps, according to some embodiments.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

This specification discloses one or more embodiments that incorporate the features of this disclosure. The disclosed embodiment(s) are merely exemplary. The scope of the disclosure is not limited to the disclosed embodiment(s), but rather is defined by the claims appended hereto.

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Spatially relative terms, such as “beneath,” “below,” “lower,” “above,” “on,” “upper,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (e.g., rotated 90 degrees or at other orientations), and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1-15% of the value (e.g., ±1%, ±2%, ±5%, ±10%, or ±15% of the value).

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

Embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, and/or instructions may be described herein as performing certain actions. However, it should be appreciated that such descriptions are merely for convenience and that such actions in fact result from computing devices, processors, controllers, or other devices executing the firmware, software, routines, instructions, etc.

Bonding of glass-to-glass substrates and other transparent and non-transparent substrates can be useful for microfluidic applications, encapsulating organic electronic components (e.g., organic light emitting diodes), as well as other applications. Hermetic bonding can seal liquids or other components (e.g., organic components) between the substrates. Laser bonding processes can provide electrically conductive and/or non-conductive bonding for various devices.

A laser bond can make use of a bonding layer between a first substrate and a second substrate to absorb laser energy from the bonding laser. The bonding layer can be conductive or non-conductive. One of the substrates (e.g., the first substrate) can be transparent to the bonding laser. After absorbing the laser energy, the bonding layer and the substrates adjacent to the bonding layer can be heated along a bond track of the bonding laser. The heated region of the bonding layer and the adjacent substrates can be softened or melted and subsequently bonded together. As a result, the bonding layer can bond the first and the second substrates and create a conductive or non-conductive bond across the bonded region. The bond can be hermetic to protect the liquids or other components sealed between the substrates from air, water, or other potentially reactive materials. For example, the bond can hermetically seal the liquids or other components between the substrates.

Conductive and non-conductive bonds made using laser bonding processes can be useful for microfluidic applications, encapsulating organic electronic components (e.g., organic light emitting diodes), as well as other applications. One exemplary use of the laser bonds is in liquid lens apparatus.

Exemplary Liquid Lens Apparatus

Liquid lenses generally include two immiscible liquids disposed within a cavity disposed between a first window and a second window. Varying an electric field to which the liquids are subjected can vary the wettability of one of the liquids with respect to the cavity wall, thereby varying the shape of the meniscus formed between the two liquids and, thus, changing the optical focal length of the liquid lens.

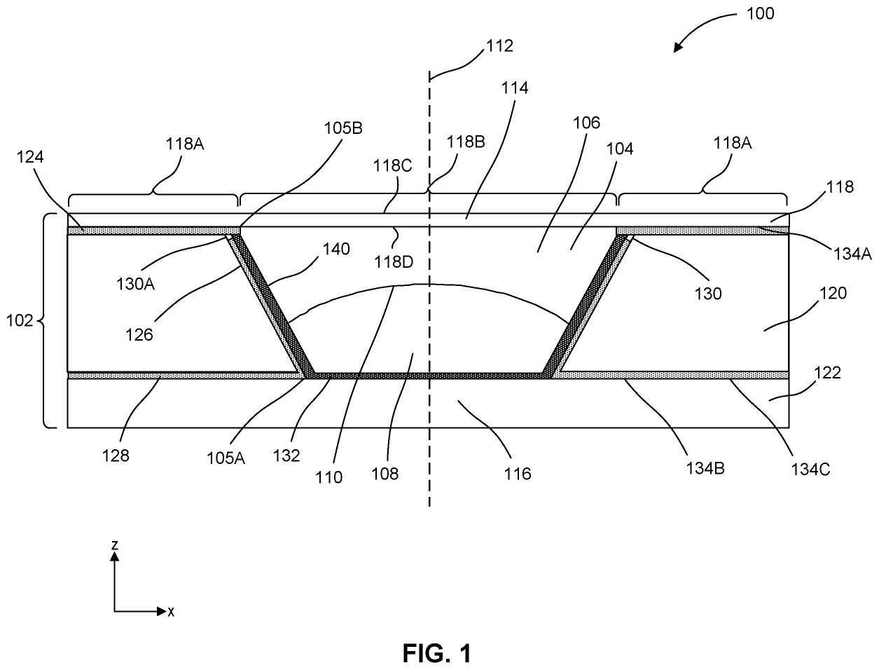

FIG. 1 illustrates a schematic cross-sectional view of liquid lens apparatus 100, according to some embodiments. In some embodiments, liquid lens apparatus 100 can include a lens body 102 and a cavity 104 formed in the lens body 102. A first liquid 106 and a second liquid 108 can be disposed within cavity 104. In some embodiments, first liquid 106 can be a polar liquid or a conducting liquid. Additionally, or alternatively, second liquid 108 can be a non-polar liquid or an insulating liquid. In some embodiments, first liquid 106 and second liquid 108 have different refractive indices such that an interface 110 between first liquid 106 and second liquid 108 forms a lens. In some embodiments, first liquid 106 and second liquid 108 have substantially the same density, which can help to avoid changes in the shape of interface 110 as a result of changing the physical orientation of liquid lens apparatus 100 (e.g., as a result of gravitational forces).

In some embodiments, first liquid 106 and second liquid 108 can be in direct contact with each other at interface 110. For example, first liquid 106 and second liquid 108 can be substantially immiscible with each other such that the contact surface between first liquid 106 and second liquid 108 defines interface 110. In some embodiments, first liquid 106 and second liquid 108 can be separated from each other at interface 110. For example, first liquid 106 and second liquid 108 can be separated from each other by a membrane (e.g., a polymeric membrane) that defines interface 110.

Interface 110 can be adjusted via electrowetting. Electrowetting can include a modification of the wetting properties or wettability (e.g., ability of a liquid to maintain contact with a surface) of a surface with an applied electric field. For example, a voltage can be applied between first liquid 106 and a surface of cavity 104 (e.g., an electrode positioned near the surface of the cavity 104 and insulated from first liquid 106, as described herein) to increase or decrease the wettability of the surface of the cavity 104 with respect to the first liquid 106 and change the shape of interface 110. In some embodiments, adjusting interface 110 changes the shape of the interface, which changes the focal length or focus of liquid lens apparatus 100. For example, such a change of focal length can enable liquid lens apparatus 100 to perform an autofocus function. Additionally, or alternatively, adjusting interface 110 tilts the interface relative to a structural axis 112 of liquid lens apparatus 100 (e.g., to tilt an optical axis of liquid lens apparatus 100 relative to the structural axis of liquid lens apparatus 100). For example, such tilting can enable liquid lens apparatus 100 to perform an optical image stabilization (OIS) function. Adjusting interface 110 can be achieved without physical movement of liquid lens apparatus 100 relative to an image sensor, a fixed lens or lens stack, a housing, or other components of a camera module in which liquid lens apparatus 100 can be incorporated.

In some embodiments, lens body 102 of liquid lens apparatus 100 can include a first window 114 and a second window 116. In some of such embodiments, cavity 104 can be disposed between first window 114 and second window 116. In some embodiments, lens body 102 can include a plurality of layers that cooperatively form the lens body 102. For example, in the embodiments shown in FIG. 1, lens body 102 can include a first outer layer, or first substrate, 118, an intermediate layer, or second substrate, 120, and a second outer layer, or third substrate, 122. In some embodiments, first substrate 118 can be or can include a flexible membrane. First substrate 118 can include a central portion 118B and a peripheral portion 118A. In some embodiments, central portion 118B can coincide with first window 114. First substrate 118 can include an exterior side 118C (e.g., upper surface of lens body 102) and an interior side 118D (e.g., facing first liquid 106). In some embodiments, second substrate 120 can include a bore formed therethrough. For example, second substrate 120 can include cavity 104. First substrate 118 can be bonded to one side (e.g., the object side) of second substrate 120. For example, first substrate 118 (e.g., peripheral portion 118A) can be bonded to second substrate 120 at a bond 134A. Bond 134A can be an adhesive bond, a laser bond (e.g., a laser weld), or another suitable bond capable of maintaining first liquid 106 and second liquid 108 within cavity 104 (e.g., sealing first liquid 106 and second liquid 108 within cavity 104, or hermetically sealing cavity 104). Additionally, or alternatively, third substrate 122 can be bonded to the other side (e.g., the image side) of second substrate 120 (e.g., opposite first substrate 118). For example, third substrate 122 can bonded to second substrate 120 at a bond 134B and/or a bond 134C, each of which can be configured as described herein with respect to bond 134A. In some embodiments, intermediate layer 120 can be disposed between first outer layer 118 and second outer layer 122, the bore in the intermediate layer 120 can be covered on opposing sides by the first outer layer 118 and the second outer layer 122, and at least a portion of cavity 104 can be defined within the bore. Thus, a portion of first outer layer 118 covering cavity 104 serves as first window 114, and a portion of second outer layer 122 covering cavity 104 serves as second window 116.

In some embodiments, cavity 104 can be defined by the bore in intermediate layer 120. In some embodiments, cavity 104 can be tapered as shown in FIG. 1 such that a cross-sectional area of at least a portion of the cavity decreases along structural axis 112 in a direction from the object side (e.g., first substrate 118) toward the image side (e.g., third substrate 122). For example, cavity 104 can include a narrow end 105A and a wide end 105B. The terms “narrow” and “wide” are relative terms, meaning the narrow end is narrower, or has a smaller width or diameter, than the wide end. Such a tapered cavity 104, or a portion thereof can have a substantially truncated conical cross-sectional shape. Additionally, or alternatively, such a tapered cavity 104 can help to maintain alignment of interface 110 between first liquid 106 and second liquid 108 along structural axis 112. In other embodiments, cavity 104 can be tapered such that the cross-sectional area of cavity 104 increases along structural axis 112 in the direction from the object side (e.g., first substrate 118) to the image side (e.g., third substrate 122) or non-tapered such that the cross-sectional area of cavity 104 remains substantially constant along structural axis 112. In some embodiments, cavity 104 can be rotationally symmetrical (e.g., about structural axis 112 of liquid lens apparatus 100).

In some embodiments, image light can enter liquid lens apparatus 100 through first window 114, can be refracted at interface 110 between first liquid 106 and second liquid 108, and can exit liquid lens apparatus 100 through second window 116. In some embodiments, first outer layer 118 and/or second outer layer 122 can include a sufficient transparency to enable passage of the image light. For example, first outer layer 118 and/or second outer layer 122 can include a polymeric, glass, ceramic, glass-ceramic material, or the like. In some embodiments, outer surfaces of first outer layer 118 and/or second outer layer 122 can be substantially planar. Thus, even though liquid lens apparatus 100 can function as a lens (e.g., by refracting image light passing through interface 110), outer surfaces of liquid lens apparatus 100 can be flat as opposed to being curved like the outer surfaces of a fixed lens. Such planar outer surfaces can make integrating liquid lens apparatus 100 into an optical assembly (e.g., a lens stack) less difficult. In other embodiments, outer surfaces of the first outer layer 118 and/or the second outer layer 122 are curved (e.g., concave or convex). Thus, liquid lens apparatus 100 can include an integrated fixed lens. In some embodiments, intermediate layer 120 can include a metallic, polymeric, glass, ceramic, glass-ceramic material, or the like. Because image light can pass through the bore (e.g., cavity 104) in intermediate layer 120, intermediate layer 120 may or may not be transparent.

Although lens body 102 of liquid lens apparatus 100 is described as including first outer layer 118, intermediate layer 120, and second outer layer 122, other embodiments are included in this disclosure. For example, in some other embodiments, one or more of the layers can be omitted. For example, the bore in intermediate layer 120 can be configured as a blind hole that does not extend entirely through intermediate layer 120, and second outer layer 122 can be omitted.

In some embodiments, liquid lens apparatus 100 can include a common electrode 124 in electrical communication with first liquid 106. Additionally, or alternatively, liquid lens apparatus 100 can include a driving electrode 126 disposed on a sidewall 140 of cavity 104 and insulated from first liquid 106 and second liquid 108. Different voltages can be supplied to common electrode 124 and driving electrode 126 (e.g., different potentials can be supplied between common electrode 124 and driving electrode 126) to change the shape of interface 110 as described herein.

In some embodiments, liquid lens apparatus 100 can include a conducting layer 128, at least a portion of which is disposed within cavity 104 and/or defines at least a portion of the sidewall 140 of the cavity 104. For example, conducting layer 128 can include a conductive coating applied to intermediate layer 120 prior to bonding first outer layer 118 and/or second outer layer 122 to intermediate layer 120. Conducting layer 128 can include a metallic material, a conductive polymer material, another suitable conductive material, or a combination thereof. Additionally, or alternatively, conducting layer 128 can include a single layer or a plurality of layers, some or all of which can be conductive. In some embodiments, conducting layer 128 can define common electrode 124 and/or driving electrode 126. For example, conducting layer 128 can be applied to substantially the entire outer surface of intermediate layer 120 prior to bonding first outer layer 118 and/or second outer layer 122 to intermediate layer 120. Following application of conducting layer 128 to intermediate layer 120, conducting layer 128 can be segmented into various conductive elements (e.g., common electrode 124, driving electrode 126, and/or other electrical devices). In some embodiments, liquid lens apparatus 100 can include one or more scribes 130 in conducting layer 128 to isolate (e.g., electrically isolate) common electrode 124 and driving electrode 126 from each other. For example, scribe 130A can be formed by a photolithographic process, a laser process (e.g., laser ablation), or another suitable scribing process. In some embodiments, scribes 130 can include a gap in conducting layer 128. For example, scribe 130A can be a gap with a width of about 5 μm, about 10 μm, about 15 μm, about 20 μm, about 25 μm, about 30 μm, about 35 μm, about 40 μm, about 45 μm, about 50 μm, or any ranges defined by the listed values. Scribes 130 can be configured as gaps or channels formed in conducting layer 128, which can serve as a bonding layer for a laser bonding process as described herein. For example, a bond track used to seal first liquid 106 and second liquid 108 inside cavity 104 can intersect scribes 130, and a seal (e.g., a hermetic seal) can be maintained across the scribes.

Although conducting layer 128 is described in reference to FIG. 1 as being segmented following application to intermediate layer 120, other embodiments are included in this disclosure. For example, in some embodiments, conducting layer 128 can be patterned during application to intermediate layer 120. For example, a mask can be applied to intermediate layer 120 prior to applying conducting layer 128 such that, upon application of conducting layer 128, masked regions of intermediate layer 120 covered by the mask can correspond to the gaps in conducting layer 128, and upon removal of the mask, the gaps are formed in conducting layer 128.

In some embodiments, liquid lens apparatus 100 can include an insulating layer 132 disposed within cavity 104. For example, insulating layer 132 can include an insulating coating applied to intermediate layer 120 prior to bonding first outer layer 118 and/or second outer layer 122 to intermediate layer 120. In some embodiments, insulating layer 132 can include an insulating coating applied to conducting layer 128 and second window 116 after bonding second outer layer 122 to intermediate layer 120 and prior to bonding first outer layer 118 to intermediate layer 120. Thus, insulating layer 132 can cover at least a portion of conducting layer 128 within cavity 104 (e.g., driving electrode 126) and second window 116. In some embodiments, insulating layer 132 can be sufficiently transparent to enable passage of image light through second window 116 as described herein. Insulating layer 132 can include polytetrafluoroethylene (PTFE), parylene, another suitable polymeric or non-polymeric insulating material, or a combination thereof. Additionally, or alternatively, insulating layer 132 can include a hydrophobic material. Additionally, or alternatively, insulating layer 132 can include a single layer or a plurality of layers, some or all of which can be insulating.

In some embodiments, insulating layer 132 can cover at least a portion of driving electrode 126 (e.g., the portion of the driving electrode disposed within cavity 104) to insulate first liquid 106 and second liquid 108 from driving electrode 126. Additionally, or alternatively, at least a portion of common electrode 124 can be disposed within cavity 104 and uncovered by insulating layer 132. Thus, common electrode 124 can be in electrical communication with first liquid 106 as described herein. In some embodiments, insulating layer 132 can include a hydrophobic surface layer in cavity 104. Such a hydrophobic surface layer can help to maintain second liquid 108 within a lower portion of cavity 104 (e.g., by attraction between the non-polar second liquid 108 and the hydrophobic material) and/or enable the perimeter of interface 110 to move along the hydrophobic surface layer (e.g., by electrowetting) to change the shape of the interface 110 as described herein.

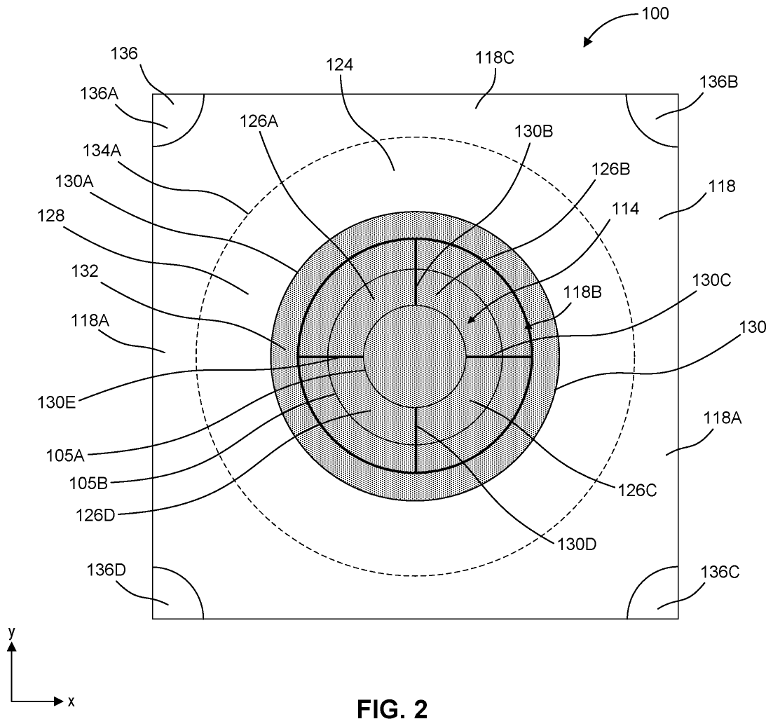

FIG. 2 illustrates a schematic top plan view of liquid lens apparatus 100 shown in FIG. 1, looking through first outer layer 118, according to some embodiments. For clarity in FIG. 2, and with some exceptions, bonds (e.g., 134A, 134B, 134C) generally are shown in dashed lines, scribes (e.g., 130, 130A, 130B, 130C, 130D, 130E) generally are shown in heavier lines, and other features generally are shown in lighter lines.

In some embodiments, common electrode 124 is defined between scribe 130A and an outer edge of liquid lens apparatus 100. A portion of common electrode 124 can be uncovered by insulating layer 132 such that common electrode 124 can be in electrical communication with first liquid 106 as described herein. In some embodiments, bond 134A can be configured such that electrical continuity can be maintained between the portion of conducting layer 128 inside the bond (e.g., inside cavity 104 and/or between the bond and scribe 130A) and the portion of conducting layer 128 outside the bond (e.g., outside cavity 104 and/or outside the bond). For example, bond 134A can be configured as a soft laser bond as described herein. In some embodiments, liquid lens apparatus 100 can include one or more cutouts 136 in first outer layer 118. For example, as shown in FIG. 2, liquid lens apparatus 100 can include a first cutout 136A, a second cutout 136B, a third cutout 136C, and a fourth cutout 136D. In some embodiments, cutouts 136 can include portions of liquid lens apparatus 100 at which first outer layer 118 is removed to expose conducting layer 128. Thus, cutouts 136 can enable electrical connection to common electrode 124, and the regions of conducting layer 128 exposed at the cutouts can serve as contacts to enable electrical connection of liquid lens apparatus 100 to a controller, a processor, a driver, or another component of a lens or camera system.

Although cutouts 136 are described herein as being positioned at corners of liquid lens apparatus 100, other embodiments are included in this disclosure. For example, in some embodiments, one or more of the cutouts 136 can be disposed inboard of the outer perimeter of liquid lens apparatus 100 and/or along one or more edges of liquid lens apparatus 100.

In some embodiments, driving electrode 126 can include a plurality of driving electrode segments. For example, as shown in FIG. 2, driving electrode 126 can include a first driving electrode segment 126A, a second driving electrode segment 126B, a third driving electrode segment 126C, and a fourth driving electrode segment 126D. In some embodiments, the driving electrode segments 126A-126D can be distributed substantially uniformly about sidewall 140 of cavity 104. For example, each driving electrode segment can occupy about one quarter, or one quadrant, of sidewall 140 of cavity 104. In some embodiments, adjacent driving electrode segments 126A-126D are isolated from each other by a scribe. For example, first driving electrode segment 126A and second driving electrode segment 126B can be isolated from each other by scribe 130B. Additionally, or alternatively, second driving electrode segment 126B and third driving electrode segment 126C are isolated from each other by a scribe 130C. Additionally, or alternatively, third driving electrode segment 126C and fourth driving electrode segment 126D are isolated from each other by a scribe 130D. Additionally, or alternatively, fourth driving electrode segment 126D and first driving electrode segment 126A are isolated from each other by a scribe 130E. The various scribes 130 can be configured as described herein in reference to scribe 130A. In some embodiments, the scribes between the various electrode segments extend beyond cavity 104 and onto the back side of liquid lens apparatus 100 (not shown). Such a configuration can ensure electrical isolation of the adjacent driving electrode segments 126A-126D from each other. Additionally, or alternatively, such a configuration can enable each driving electrode segment 126A-126D to have a corresponding contact for electrical connection as described herein.

Although driving electrode 126 is described herein as being divided into four driving electrode segments 126A-126D, other embodiments are included in this disclosure. In some other embodiments, driving electrode 126 can include a single driving electrode (e.g., substantially circumscribing sidewall 140 of cavity 104). For example, the liquid lens comprising such a single driving electrode can be capable of varying focal length, but incapable of tilting the interface (e.g., an autofocus only liquid lens). In some other embodiments, the driving electrode 126 can be divided into two, three, five, six, seven, eight, or more driving electrode segments (e.g., distributed substantially uniformly about sidewall 140 of cavity 104).

In some embodiments, bond 134B and/or bond 134C can be configured such that electrical continuity is maintained between the portion of conducting layer 128 inside the respective bond and the portion of the conducting layer outside the respective bond. In some embodiments, liquid lens apparatus 100 can include one or more cutouts 136 in second outer layer 122. For example, liquid lens apparatus 100 can include similar cutouts 136A-136D, shown in FIG. 2 in first outer layer 118, in second outer layer 122. In some embodiments, cutouts 136 can include portions of liquid lens apparatus 100 at which second outer layer 122 is removed to expose conducting layer 128. Thus, cutouts 136 can enable electrical connection to driving electrode 126, and the regions of conducting layer 128 exposed at cutouts 136 can serve as contacts to enable electrical connection of liquid lens apparatus 100 to a controller, a processor, a driver, or another component of a lens or camera system.

Different driving voltages can be supplied to different driving electrode segments to tilt the interface of liquid lens apparatus 100 (e.g., for OIS functionality). For example, tilting interface 110 can cause an angle to be formed between the optical axis of liquid lens apparatus 100 (e.g., the optical axis of interface 110) and structural axis 112 of liquid lens apparatus 100. In some embodiments, such an angle can be referred to as a mechanical tilt angle, and an optical tilt angle of liquid lens apparatus 100 can be determined based on the mechanical tilt angle and the refractive index difference Δn between first liquid 106 and second liquid 108. Additionally, or alternatively, a driving voltage can be supplied to a single driving electrode or the same driving voltage can be supplied to each driving electrode segment to maintain interface 110 of liquid lens apparatus 100 in a substantially spherical orientation about structural axis 112 (e.g., for autofocus functionality) and/or to maintain the optical axis in alignment with structural axis 112.

In some embodiments, first outer layer 118 can include a peripheral portion 118A, a central portion 118B, an exterior side 118C, and an interior side 118D, as shown in FIG. 1. For example, peripheral portion 118A can be disposed laterally outboard (or farther from structural axis 112) of central portion 118B. In some embodiments, central portion 118B can include first window 114. For example, central portion 118B can at least partially overlie cavity 104, whereby at least a portion of central portion 118B of first outer layer 118 can serve as first window 114. In some embodiments, peripheral portion 118A of first outer layer 118 can be bonded to intermediate layer 120 (e.g., at bond 134A) as described herein. In some embodiments, first outer layer 118 can include a monolithic or unitary body (e.g., formed from a single piece of material such as, for example, a glass substrate). For example, each of peripheral portion 118A and central portion 118B can be part of the monolithic first outer layer 118.

In some embodiments, first outer layer 118 can include a thinned region or membrane. For example, the thinned region can have a lower stiffness than peripheral portion 118A and/or central portion 118B of first outer layer 118, which can enable first window 114 to move or expand (e.g., translate axially) as described herein. In some embodiments, the thinned region can comprise an annular thinned region, which can at least partially circumscribe first window 114 and/or cavity 104. In some embodiments, central portion 118B can include a thinned region or membrane. For example, the thinned region can be in communication with the bore in intermediate layer 120, as shown in FIG. 1, such that the bore and the thinned region cooperatively define cavity 104.

In some embodiments, central portion 118B of first outer layer 118 enables first window 114 to translate relative to peripheral portion 118A in the axial direction. For example, a reduced stiffness of a thinned region of central portion 118B compared to peripheral portion 118A can enable the first outer layer 118 to flex or bend at the thinned region (e.g., central portion 118B). Such flexing or bending can be caused, for example, by expansion or contraction of first liquid 106 and/or second liquid 108 within cavity 104 (e.g., as a result of an increase or decrease in temperature), by physical shock to first outer layer 118, or by another force exerted on first outer layer 118 (e.g., from inside or outside cavity 104). Such flexing or bowing of central portion 118B and first window 114 can cause a change in optical power (e.g., focal length or focus) of liquid lens apparatus 100 resulting from a change in curvature of first window 114.

In some embodiments, a thickness of peripheral portion 118A of first outer layer 118 is substantially the same as a thickness of central portion 118B and/or first window 114. Additionally, or alternatively, a substantially uniform thickness of peripheral portion 118A and central portion 118B and/or first window 114, can enable first outer layer 118 to be formed from a substantially planar sheet of material without thinning the central portion 118B and/or the first window 114 (e.g., without etching, grinding, or polishing the central portion and/or the first window to reduce the thickness thereof). Avoiding such a thinning step can help to maintain the surface quality of first window 114, which can improve the image quality of liquid lens apparatus 100 compared to liquid lenses with thinned window regions. Additionally, or alternatively, avoiding such a thinning step can reduce the number of steps involved in manufacturing first outer layer 118 compared to liquid lenses with thinned window regions, thereby simplifying production of liquid lens apparatus 100. In some embodiments, a thickness of first outer layer 118 can be about 25 μm to about 250 μm. For example, central portion 118B and/or first window 114 can have a thickness of about 25 μm to about 50 μm.

In some embodiments, cavity 104 can include a sidewall 140 extending between first outer layer 118 and second window 116. For example, sidewall 140 can be defined by the bore in intermediate layer 120 (e.g., a wall of the bore) and/or conducting layer 128 (e.g., a portion of the conducting layer disposed on a portion of the wall of the bore). In some embodiments, sidewall 140 can be straight (e.g., along the sidewall of cavity 104 in the axial direction). For example, the deviation of sidewall 140 from linear, measured along an entire height of the sidewall in the axial direction, is at most about 50 μm, at most about 40 μm, at most about 30 μm, at most about 20 μm, at most about 10 μm, at most about 5 μm, or any ranges defined by the listed values.

Although liquid lens apparatus 100 is described herein as comprising an electrowetting-based liquid lens, other embodiments are included in this disclosure. In some embodiments, the liquid lens apparatus comprises a variable focus lens, which can be a liquid lens (e.g., an electrowetting-based liquid lens as described in reference to liquid lens apparatus 100), a hydrostatic fluid lens (e.g., comprising a fluid or polymeric material disposed within a flexible membrane with a curvature that is variable, for example, by injecting or withdrawing fluid and/or by applying an external force to the fluid lens), a liquid crystal lens, or another type of lens having a focal length that can be changed (e.g., without translating, tilting, or otherwise moving the lens assembly relative to the image sensor).

Exemplary Electrically Conductive Hermetic Bonds

In some embodiments, the first substrate of a liquid lens can be bonded to the second substrate by a laser bond to seal (e.g., hermetically seal) the liquids in the cavity. In some embodiments, a hard laser bond can be formed to bond structures and form isolating, non-conducting bonded regions. The hard laser bond can be formed using higher laser energy to bond the structures. For example, hard laser bonding processes can be performed using a laser power from about 30 mW to about 50 mW for a pulsed laser with about 10 μm beam spot, about 100 mm/s marking speed and about 80 kHz repetition rate. Additionally, or alternatively, a soft laser bond can be formed to bond structures and form non-isolating, conducting bonded regions. The soft laser bond can be formed using lower laser power density (e.g., lower laser energy with the same spot size and/or the same translation speed) to bond the structures. For example, soft laser bonding processes can be performed using a laser power from about 20 mW to about 25 mW for a pulsed laser with about 10 μm beam spot, about 100 mm/s marking speed and about 80 kHz repetition rate. In some embodiments, the laser power density and exposure time of a pulsed laser can be adjusted by adjusting the laser pulse energy, focus, marking speed, or a combination thereof. In some embodiments, a continuous wave laser can be used to form a soft laser bond. In some of such embodiments, the power of a continuous wave laser can be adjusted by adjusting the laser power density, exposure time, or a combination thereof. In some embodiments, a continuous wave laser can form a laser bond track that is free or substantially free of spots and/or improve the hermeticity of the laser bond.

Hard laser bonding can be used in liquid lens packages for electrical isolation in metal patterns (e.g., to form the various electrodes that can be used to manipulate the liquid lens meniscus as described herein). However, such hard bonding can result in ripped metal interfacial wall topologies, form sharp asperities (e.g., from high local electric fields), and/or contribute to non-uniform package-to-package behavior, hysteresis, poor reliability, and/or poor yields. Hard bonding can also ablate metal films and produce a non-uniform range of particulate size, which can lead to non-uniform package-to-package behavior. Hard laser bonding can also involve larger laser energy and time to create an individual metal pattern on a single liquid lens package (e.g., compared to alternative patterning processes), thereby limiting product output and volume manufacturing.

In some embodiments, a soft laser bond can be formed in a soft laser bonding process to bond structures and form hermetic and/or conductive bonded regions. In some embodiments, soft laser bonds can have improved metal interfacial topologies and be substantially continuous between the first substrate and the second substrate (e.g., compared to hard laser bonds). In some embodiments, soft laser bonding can improve liquid lens package to package uniformity, hysteresis, reliability, and yields (e.g., compared to hard laser bonding) In some embodiments, soft laser bonds with patterned gaps can create metal patterns using one or more pattering processes, which can improve product output and/or volume manufacturing. In some embodiments, soft laser bonding can produce sufficient transmission (e.g., in the bond track across patterned gaps formed using one or more patterning process and/or at the periphery of a liquid lens package) to enable dicing individual liquid lenses from a wafer using a laser dicing process.

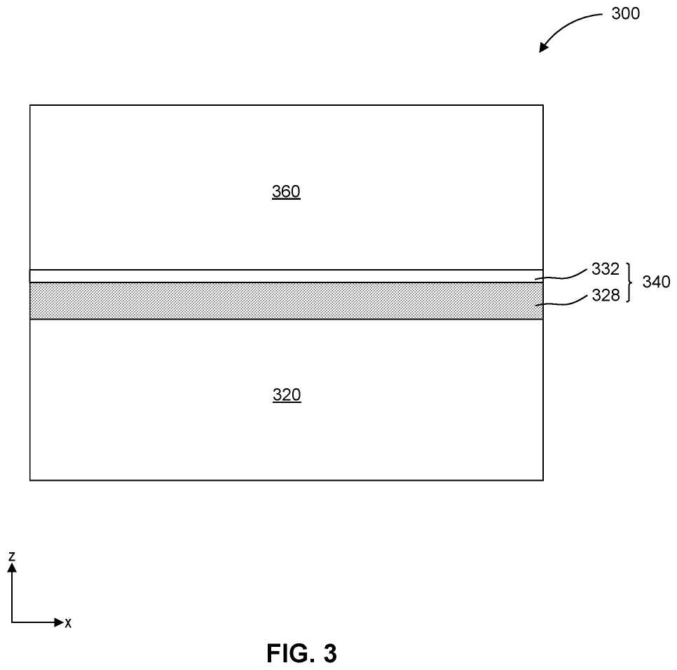

FIG. 3 illustrates a schematic cross-sectional view of a laser bonding structure 300, according to some embodiments. In some embodiments, laser bonding structure 300 can include a bottom substrate 320, a bonding layer 340, and a top substrate 360. In some embodiments, the material of bottom substrate 320 can be similar to intermediate layer 120, including a metallic, semiconductor, polymeric, glass, ceramic, glass-ceramic material, or the like. In some embodiments, bottom substrate 320 may or may not be transparent. Additionally, or alternatively, bottom substrate 320 can be the same or a different material than top substrate 360. In some embodiments, bottom substrate 320 can have a thickness from about 0.3 mm to about 1.0 mm, or similar. Additionally, or alternatively, bottom substrate 320 can include a single layer or a plurality of layers.

In some embodiments, bonding layer 340 can be disposed between bottom substrate 320 and top substrate 360. Bonding layer 340 can absorb laser energy passing through top substrate 360, thereby creating a localized heating region to soften and/or melt top substrate 360 and bottom substrate 320 proximate to the localized heating region, and bond top substrate 360 and bottom substrate 320 proximate to the localized heating region. In some embodiments, bonding layer 340 can have a thickness in a range from about 100 nm to about 250 nm. Additionally, or alternatively, bonding layer 340 can include a single layer or a plurality of layers, some or all of which can absorb laser energy. In some embodiments, bonding layer 340 can include a conducting layer and a capping layer. In some embodiments, bonding layer 340 can include a plurality of conducting layers and/or a plurality of capping layers (e.g., a first conducting layer, a first capping layer, a second conducting layer, and a second capping layer, which can be arranged in an alternating stack).

In some embodiments, bonding layer 340 can include a conducting layer 328 and a capping layer 332. In some embodiments, conducting layer 328 can be disposed on bottom substrate 320 and capping layer 332 can be disposed on conducting layer 328. For example, conducting layer 328 can be positioned between bottom substrate 320 and capping layer 332. Conducting layer 328 can include a metallic material, a conductive polymer material, another suitable conductive material, or a combination thereof. In some embodiments, conducting layer 328 can include chromium (Cr), nickel (Ni), gold (Au), silver (Ag), aluminum (Al), tungsten (W), cobalt (Co), iron (Fe), titanium (Ti), molybdenum (Mo), alloys thereof, or a combination thereof. In some embodiments, conducting layer 328 can have a thickness in a range from about 100 nm to about 200 nm. Conducting layer 328 with a thickness thinner than 100 nm may not be sufficiently conducting (especially after laser bonding), and conducting layer 328 with a thickness thicker than 200 nm may introduce extra stress after the bonding process. In some embodiments, conducting layer 328 can be sufficiently opaque to absorb laser energy at the wavelength of the bonding laser. In some embodiments, conducting layer 328 can absorb laser energy at a wavelength of about 355 nm. Additionally, or alternatively, conducting layer 328 can include a single layer or a plurality of layers, some or all of which can be conductive.

In some embodiments, capping layer 332 can include an insulating coating applied to conducting layer 328. In some embodiments, the thickness of capping layer 332 can act as an anti-reflective coating (e.g., at the wavelength of the bonding laser), which can help to constrain the laser energy (e.g., from the bonding laser) in bonding layer 340. In some embodiments, capping layer 332 can have a thickness in a range from about 25 nm to about 75 nm. In some embodiments, capping layer 332 can be sufficiently transparent to enable passage of the bonding laser beam. Capping layer 332 can include an oxide and/or nitride material (e.g., chromium oxynitride (CrON), silicon nitride (SiN), or another suitable metal, non-metal, or semiconductor oxide material), a polymeric material (e.g., polytetrafluoroethylene (PTFE), parylene, or another suitable polymeric material), a non-polymeric material, another suitable material, or a combination thereof. Additionally, or alternatively, capping layer 332 can include a single layer or a plurality of layers, some or all of which can be insulating.

In some embodiments, conducting layer 328 and/or capping layer 332 can be continuous layers blanket deposited on bottom substrate 320. In some embodiments, conducting layer 328 and/or capping layer 332 can be patterned on bottom substrate 320. In some embodiments, conducting layer 328 can be patterned to have a patterned gap forming a channel as described herein. Additionally, or alternatively, capping layer 332 can be deposited across the patterned gap also as described herein. In some embodiments, conducting layer 328 and/or capping layer 332 can be deposited on bottom substrate 320 by physical vapor deposition (PVD), chemical vapor deposition (CVD), other available methods, or a combination thereof. In some embodiments, conducting layer 328 can be deposited on bottom substrate 320 by e-beam evaporation, sputtering, or other available deposition methods.

In some embodiments, the material of top substrate 360 can be similar to first outer layer 118 and/or second outer layer 122, including for example, a polymeric, glass, ceramic, glass-ceramic material, or the like. In some embodiments, top substrate 360 can have a sufficient transparency to enable passage of the bonding laser beam. In some embodiments, top substrate 360 can have a thickness from about 25 μm to about 250 μm. Additionally, or alternatively, top substrate 360 can include a single layer or a plurality of layers.

In some embodiments, top substrate 360 can be disposed on top of bonding layer 340. In some embodiments, bonding laser beam can penetrate top substrate 360 to irradiate bonding layer 340. Bonding layer 340 can absorb the laser energy and bond top substrate 360 and bottom substrate 320 together. In some embodiments, top substrate 360 and bottom substrate 320 can be bonded together by a hard laser bond, whereby bonding layer 340 can have no continuous conductive path across the hard bonded region. In some embodiments, top substrate 360 and bottom substrate 320 can be bonded together by a soft laser bond, whereby bonding layer 340 can have a continuous conductive path across the soft bonded region.

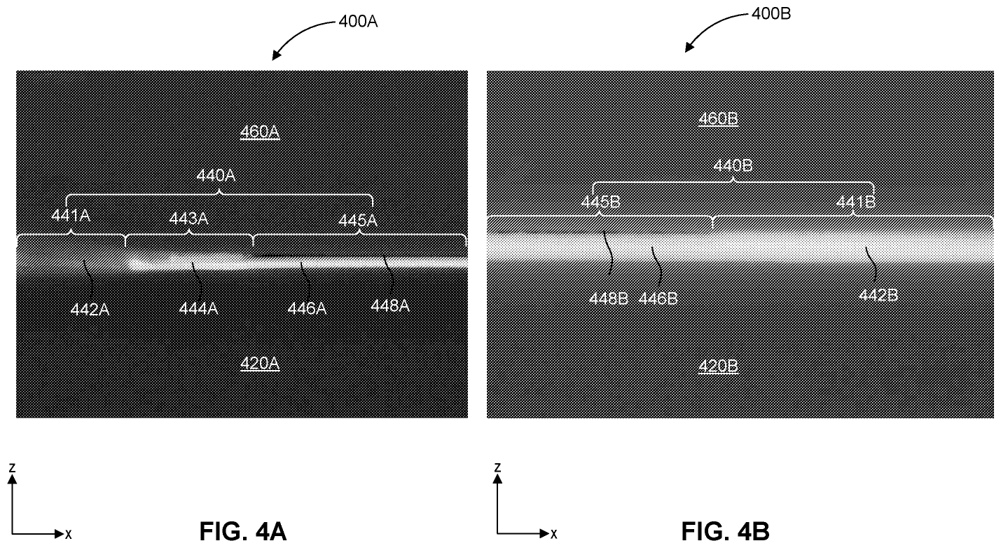

FIGS. 4A and 4B illustrate exemplary scanning electron microscopy (SEM) cross-sectional views of bonded structures 400A and 400B comprising a hard laser bond and a soft laser bond, respectively, according to some embodiments. A bond track of the bonding laser for bonded structures 400A and 400B can extend in the direction perpendicular to the plane of FIGS. 4A and 4B (e.g., along the y-axis.). As shown in FIG. 4A, bonded structure 400A can include a top substrate 460A, a bonding layer 440A, and a bottom substrate 420A bonded to top substrate 460A via bonding layer 440A by a hard laser bond, according to some embodiments. Bonding layer 440A can include a bonded region 441A, a transition region 443A, and an un-bonded region 445A. Un-bonded region 445A can include a first part of bonding layer 446A and a first gap 448A between top substrate 460A and first part of bonding layer 446A. First gap 448A can be formed after top substrate 460A is positioned on bonding layer 440A For example, first gap 448A can be an air gap formed when top substrate 460A is positioned on bonding layer 440A and before top substrate 460A is bonded to bottom substrate 420A. First gap 448A can be closed at bonded region 441A to bond top substrate 460A and bottom substrate 420A during a subsequent bonding process. In some embodiments, first gap 448A can have a thickness in a range from about 10 nm to about 100 nm between top substrate 460A and bonding layer 440A.

In transition region 443A, a second part of bonding layer 444A can bond top substrate 460A and bottom substrate 420A. Transition region 443A can have no gap between top substrate 460A and second part of bonding layer 444A. For example, second part of bonding layer 444A can be in direct contact with top substrate 460A in transition region 443A. Bonding layer 444A in transition region 443A may include topologies with sharp asperities after a laser hard bonding process.

In bonded region 441A, a laser hard bond can bond top substrate 460A and bottom substrate 420A together. A third part of bonding layer 442A can disperse into top substrate 460A and bottom substrate 420A, and bonded region 441A can form a seal (e.g., a hermetic seal) between top substrate 460A and bonding layer 442A. In some embodiments, conductive elements of bonding layer 440A can diffuse into top substrate 460A and bottom substrate 420A in bonded region 441A, whereby bonded region 441A may not be conductive. Bonding layer 440A may not form a continuous conductive path (e.g., across bonded region 441A) after the laser hard bonding process. In some embodiments, bonding layer 440A with a hard laser bond can have a resistance greater than or equal to about 10 MΩ across the hard laser bond (e.g., between opposing portions of bonding layer 440A on opposing sides of the laser bond).

In some embodiments, bonded structure 400B can include a top substrate 460B, a bonding layer 440B, and a bottom substrate 420B bonded with bonding layer 440B by a soft laser bond, as shown in FIG. 4B. Bonding layer 440B can include a bonded region 441B and an un-bonded region 445B. Un-bonded region 445B can include a fourth part of bonding layer 446B and a second gap 448B. Second gap 448 B can be formed after top substrate 460B is positioned on bonding layer 440B. The above discussion of first gap 448B can apply to second gap 448B. Second gap 448B can be closed at bonded region 441B to bond top substrate 460B and bottom substrate 420B during a subsequent bonding process. In some embodiments, second gap 448B can have a thickness in a range from about 10 nm to about 100 nm between top substrate 460B and bonding layer 440B.

In bonded region 441B, a soft laser bond can bond top substrate 460B and bottom substrate 420B together. Bonded region 441B can form a seal (e.g., a hermetic seal) between top substrate 460B and bottom substrate 420B. Fifth part of bonding layer 442B can be continuous between top substrate 460B and bottom substrate 420B after the soft laser bonding process. The resistance of bonding layer 440B can have no appreciable change across bonded region 441B after the soft laser bonding process. Bonding layer 440B can have a continuous conductive path (e.g., between opposing portions of bonding layer 440B on opposing sides of the laser bond). In some embodiments, bonding layer 440B with the soft bond can have a resistance less than or equal to about 10 kΩ, 20 kΩ, 30 kΩ, 40 kΩ, 50 kΩ, 60 kΩ, 70 kΩ, 80 kΩ, 90 kΩ, or 100 kΩ. In some embodiments, one or more of bonds 134A-C as shown in FIGS. 1-2 can include a soft laser bond to keep a continuous conductive path between both sides of the laser soft bond.

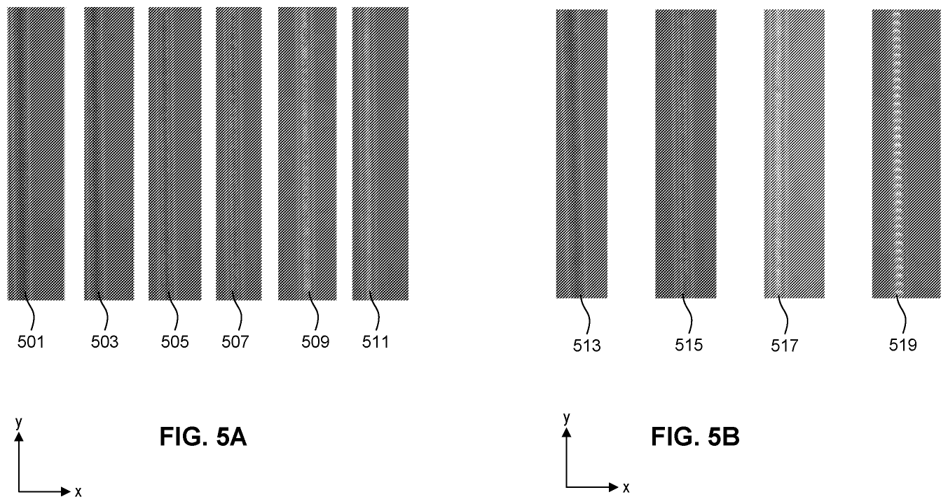

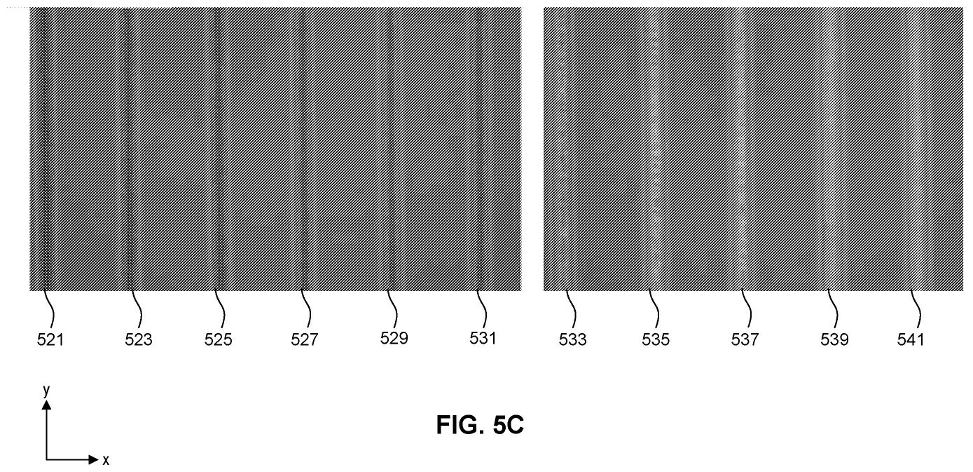

FIGS. 5A, 5B, and 5C illustrate exemplary top plan views of bond lines 501-541 formed using different laser bonding conditions, according to some embodiments. In some embodiments, pulse energy, marking speed, and/or beam focus of the bonding laser can be determined and/or adjusted to form a hard bond (e.g., electrically isolating bond) or a soft bond (e.g., electrically conductive bond) in continuous bonding layer. An electrically isolating bond can have a resistance greater than or equal to about 10 MΩ across the bond. An electrically conductive bond can have a resistance less than or equal to about 10 kΩ across the bond. A transition bond (e.g., having properties falling between the electrically isolating bond and the electrically conductive bond) can have a resistance between about 10 kΩ and about 10 MΩ across the bond.

As shown in FIG. 5A, bond lines 501-511 can be formed by varying the laser pulse energy and keeping the laser in focus and the laser marking speed unchanged for a bonding laser with a pulse width about 12.5 μs, a frequency about 80 kHz, and a marking speed about 100 mm/s. For example, with the laser pulse energy varying from about 0.4375 μJ to about 0.3875 μJ, bond lines 501 and 503 can form electrically isolating bonds. In another example, with the laser pulse energy varying from about 0.3375 μJ to about 0.3175 μJ, bond lines 505 and 507 can form transition bonds. In another example, with laser pulse energy varying from about 0.2875 μJ to about 0.2625 IA bond lines 509 and 511 can form electrically conductive bonds. In some embodiments, laser pulse energy can be adjusted by varying laser output power and keeping the laser at the same frequency. In some embodiments, laser pulse energy can be adjusted by adjusting a laser waveplate position.

Referring to FIG. 5B, bond lines 513-519 can be formed by varying laser marking speed and keeping the laser in focus and laser pulse energy unchanged for a bonding laser with a pulse width about 12.5 μs, a frequency about 80 kHz, and a laser pulse energy about 0.3125 μJ. For example, with laser marking speed about 25 mm/s for bonding line 513, the bonding laser can have a pulse to pulse overlap about 94%, and bond line 513 can form an electrically isolating bond. In another example, with laser marking speed about 100 mm/s for bonding line 515, the bonding laser can have a pulse to pulse overlap about 75%, and bond line 515 can form a transition bond. In another example, with laser marking speed varying from about 150 mm/s to 350 mm/s for bonding lines 517 and 519 respectively, the bonding laser can have a pulse to pulse overlap from about 63% to about 12%, and bond lines 517 and 519 can form electrically conductive bonds. In some embodiments, laser marking speed can be adjusted by changing the translational speed of a stage on which the bonding structure is disposed. In some embodiments, laser marking speed can be adjusted by changing the moving speed of the laser scanner.

Referring to FIG. 5C, bond lines 521-541 can be formed by varying the laser beam focus and keeping laser pulse energy and marking speed unchanged for a bonding laser with a pulse width about 12.5 μs, a frequency about 80 kHz, a marking speed about 100 mm/s, and a laser pulse energy about 0.4375 μJ. The laser beam can be in focus on the center of the thickness of bonding layer 340 to form the laser bonds. For example, with the laser beam varying from in focus to about −80 μm defocus, bond lines 521-529 can form electrically isolating bonds. As another example, with the laser beam from about −100 μm defocus to about −120 μm defocus, bond lines 531 and 533 can form transition bonds. And in another example, with the laser beam from about −140 μm defocus to about −200 μm defocus, bond lines 535 and 541 can form electrically conductive bonds. In some embodiments, adjusting the position of the bonding structure stage in a Z direction can defocus the laser beam. The Z direction can be parallel to the laser beam (e.g., an axial direction). In some embodiments, the bonding structure stage can move closer to the bonding laser (e.g., the source of the laser beam), and the bonding laser beam can focus in bottom substrate 320, resulting in negative defocus. In some embodiments, the bonding structure stage can move farther away from the bonding laser, and the bonding laser beam can focus in top substrate 360, resulting in positive defocus. Focusing the laser beam in top substrate 360 may damage top substrate 360. As bonding layer 340 can absorb most of the laser energy, focusing the laser beam in bottom substrate 320 may create minimal damage (e.g., as a result of the relatively lower energy that reaches bottom substrate 320).

Exemplary Electrically Non-Conductive Hermetic Bonds

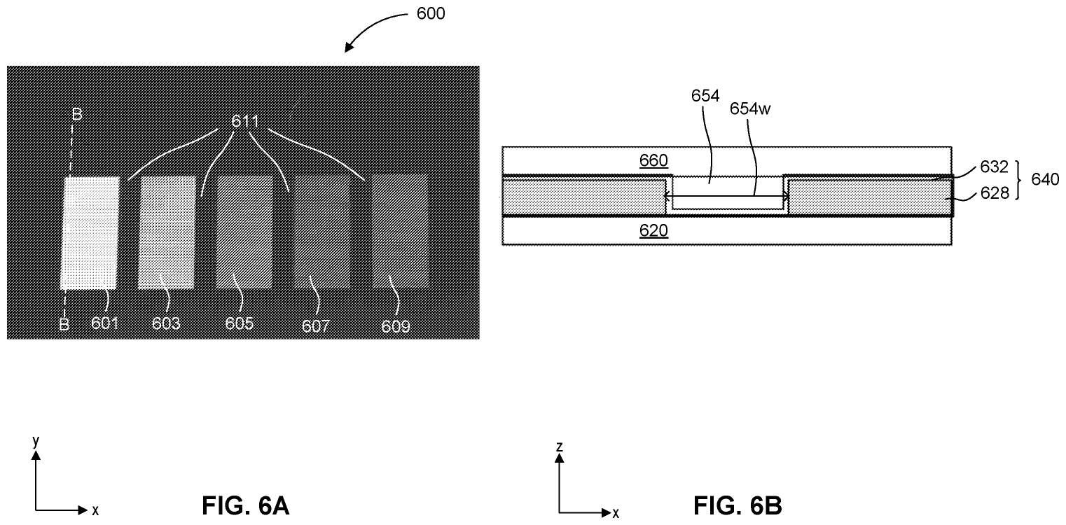

FIGS. 6A and 6B illustrate exemplary top plan and cross-sectional schematic views of a bonding structure 600 with patterned gaps, according to some embodiments. FIG. 6A can have multiple patterned gaps for patterns 601-609. In some embodiments, patterns 601-609 can have different patterned gap widths from about 0.5 μm to about 20 μm. A patterned gap width can be a width of a patterned gap (e.g., a channel width in an X direction), as shown in details of FIG. 6B cross-sectional view. For example, pattern 601 can have a pattered gap width of about 1 μm, pattern 603 can have a pattered gap width of about 1.5 μm, pattern 605 can have a pattered gap width of about 2 μm, pattern 607 can have a pattered gap width of about 5 μm, and pattern 609 can have a patterned gap width of about 10 μm. Spacings 611 between different patterns can have a width from about 200 μm to about 300 μm. According to some embodiments, a soft laser bonding process can be used to bond the top substrate and the bottom substrate across the patterned gaps.

FIG. 6B is a cross-sectional view along line B-B of one of the plurality of patterned gaps in pattern 601 in FIG. 6A. In some embodiments, bonding structure 600 can include a bottom substrate 620, a bonding layer 640, and a top substrate 660. Bottom substrate 620, bonding layer 640, and top substrate 660 can include materials similar to bottom substrate 320, bonding layer 340, and top substrate 360, respectively. Bonding layer 640 can include a capping layer 632 and a patterned conducting layer 628 with a patterned gap 654. For example, patterned gap 654 comprises a channel formed in conducting layer 628. Capping layer 632 can extend across patterned gap 654 in conducting layer 628 as shown in FIG. 6B to form a continuous layer covering conducting layer 628 and patterned gap 654. In some embodiments, capping layer 632 can include CrON. Capping layer 632 can have a thickness in a range from about 100 nm to about 200 nm. In some embodiments, conducting layer 628 can include Cr. Conducting layer 628 can have a thickness in a range from about 25 nm to about 75 nm. Patterned gap 654 can have a width 654w in a range from about 0.5 μm to about 20 μm. In some embodiments, width 654w can be similar to or smaller than a spot size of the bonding laser beam.

In some embodiments, conducting layer 628 can be patterned on bottom substrate 620 by a patterning process. For example, a mask can be applied to bottom substrate 620 prior to forming conducting layer 628 such that, upon formation of conducting layer 628, masked regions of bottom substrate 620 covered by the mask can correspond to the gaps in conducting layer 628, and upon removal of the mask, the gaps are formed in conducting layer 628. In some embodiments, patterned gap 654 can be formed after forming conducting layer 628 (e.g., by laser ablation, etching, etc.). In some embodiments, patterned gap 654 can be formed by printing conducting layer 628 onto substrate 620.

In some embodiments, capping layer 632 can be blanket deposited on conducting layer 628 (e.g., after patterning conducting layer 628). In some embodiments, patterned gap 654 can define a channel formed in bonding layer 640. In some embodiments, capping layer 632 can extend across the channel formed in bonding layer 640. In some embodiments, bonding layer 640 can be non-conductive across the channel. In some embodiments, a bond track can cross the channel in the bonding layer at an intersection and bond top substrate 660 and bottom substrate 620 at the intersection. In some embodiments, patterning of gaps in conducting layers can reduce laser time and laser energy used to create an individual pattern (e.g., an electrode) on a single liquid lens package and increase product output and volume manufacturing. For example, lithographic patterning of the gaps can replace laser ablation steps that may otherwise be used to form the gaps. In some embodiments, patterned gaps can produce sufficient transmission (e.g., can be sufficiently transmissive at a wavelength of a dicing laser and/or located at the periphery of liquid lens packages) to enable dicing wafers into individual liquid lenses using laser dicing processes. For example, the gaps of the bonding layer can be transparent to a dicing laser that can be used to singulate a wafer comprising an array of liquid lenses into individual lenses at dicing lines extending along the gaps.

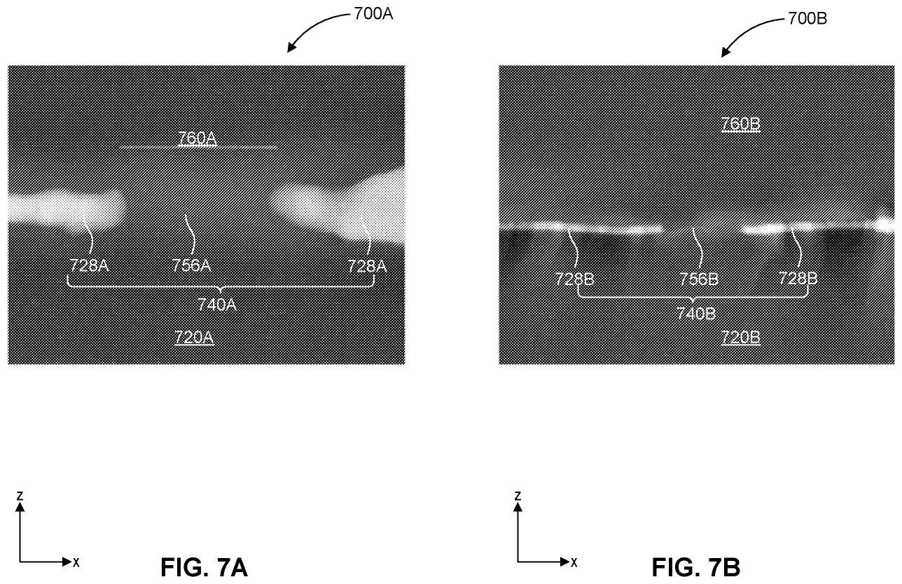

FIGS. 7A and 7B illustrate exemplary scanning electron microscopy (SEM) cross-sectional views of soft laser bonds across patterned gaps, according to some embodiments. As shown in FIG. 7A, bonded region 756A in bonding layer 740A can seal (e.g., hermetically seal) the patterned gap in conductive layer 728A (e.g., by forming a hermetic seal across an intersection between the bond path and the patterned gap). In some embodiments, bonded region 756A can have a patterned gap with a gap width from about 0.75 μm to about 1.25 μm. For example, the gap width of bonded region 756A can be about 1 μm. In some embodiments, bonded region 756A can be substantially free of voids after the soft laser bonding process. In some embodiments, in bonded region 756A, the capping layer can be at least partially dispersed into top substrate 760A, bottom substrate 720A, or both. In some embodiments, in bonded region 756A, conducting layer 728A can also be at least partially dispersed into top substrate 760A, bottom substrate 720A, or both. In some embodiments, conducting layer 728A can be non-conductive across bonded region 756A (e.g., across the bonded portion of the patterned gap) after the soft laser bonding process.

Referring to FIG. 7B, bonded region 756B in bonding layer 740B can seal (e.g., hermetically seal) the patterned gap having a larger gap width than bonded region 756A. In some embodiments, the patterned gap in bonded region 756B can have a gap width from about 1.5 μm to about 2.5 μm. For example, the gap width of bonded region 756B can be about 2 μm. In some embodiments, bonded region 756B can be substantially free of voids after the soft laser bonding process. In some embodiments, in bonded region 756B, the capping layer and/or the conducting layer can be at least partially dispersed into top substrate 760A, bottom substrate 720A, or both. In some embodiments, the inhomogeneity around conductive layer 728B (e.g., the inhomogeneity shown in FIG. 7B) can be introduced during SEM preparation process of bonded region 756B as opposed to the bonding process itself. In some embodiments, conducting layer 728B can be non-conductive across bonded region 756B (e.g., across the bonded portion of the patterned gap) after the soft laser bonding process.

In some embodiments, bonded regions 756A and 756B of soft laser bonds can be used as bonds for liquid lenses to seal liquids within a cavity. For example, bonded regions 756A and 756B can form a hermetic seal circumscribing the cavity (e.g., bond 134A described in reference to FIG. 2) to seal the liquids inside the cavity. In some embodiments, bonded regions 756A and 756B and adjacent conductive layer 728A and 728B can be substantially continuous (e.g., substantially free of voids) between the first substrate and the second substrate after the soft laser bonding process, which can help to improve liquid lens package-to-package uniformity, hysteresis, reliability and/or yields.

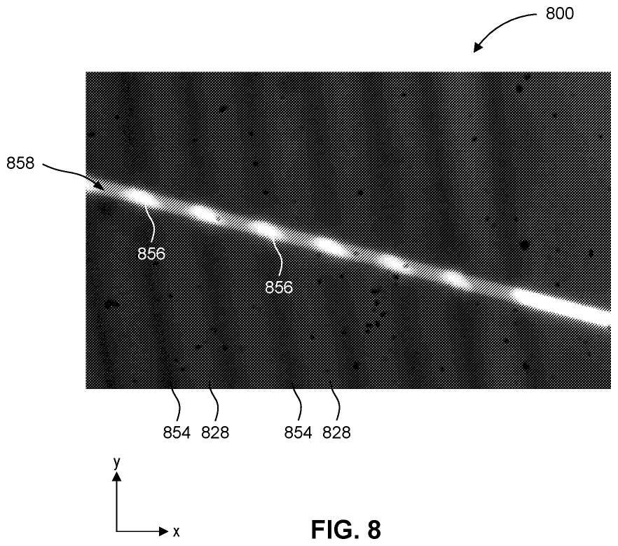

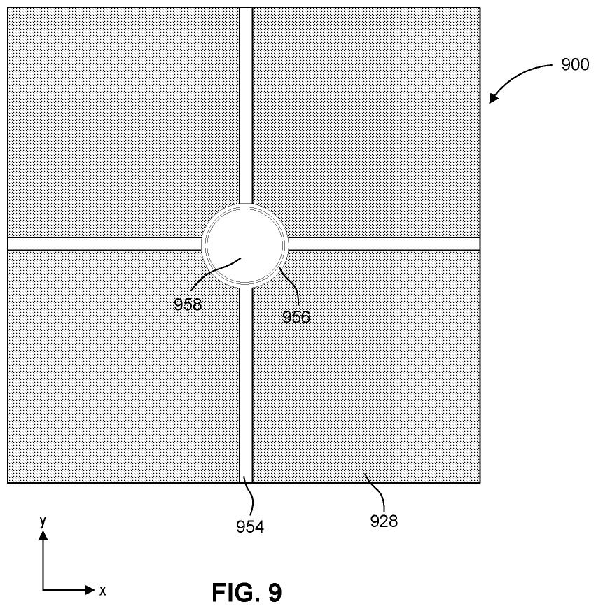

FIG. 8 illustrates an exemplary top plan view of a bonding structure 800 with patterned gaps 854, according to some embodiments. In some embodiments, FIG. 8 can represent hermetic soft bonds in bonding structure 600 after a soft laser bonding process. As shown in FIG. 8, bonding structure 800 can include conducting layer 828, patterned gaps 854 (e.g., the darker portions extending generally in the Y direction), bond track 858, and bonded regions 856 (e.g., the lighter portions of the bond track generally aligned with the patterned gaps). Bond track 858 can cross the channels defined by patterned gaps 854 and form bonded regions 856 in the bonding layer at the intersections. Bonded regions 856 can seal (e.g., hermetically seal) the channels defined by patterned gaps 854 and bond together the top substrate and the bottom substrate. A hermetic seal can prevent liquids and/or gases passing through bonded regions 856 of the channels. In some embodiments, the hermetic seal can maintain its hermeticity through a calcium patch test as described in reference to FIG. 9 for more than 1000 hours, which can correspond to about ten years under ambient operation.

FIG. 9 illustrates a schematic top plan view of a calcium patch test structure 900 with patterned gaps 954, according to some embodiments. As shown in FIG. 9, calcium patch test structure 900 can have patterned gaps 954 and conducting layer 928 formed on a bottom substrate. A calcium dot 958 can be deposited at an intersection of patterned gaps 954 in conducting layer 928 and subsequently covered by a top substrate. A chamber containing calcium dot 958 can be formed by a circular soft laser bond 956, which can bond the top substrate and the bottom substrate via conducting layer 928 as described herein. Soft laser bond 956 can extend across (e.g., intersect with) patterned gaps 954, which extend through the bond and into the chamber. As a result, calcium dot 958 can be sealed in the chamber inside soft laser bond 956. Soft laser bond 956 can keep calcium dot 958 substantially unchanged in an accelerated hermeticity test. For example, the chamber can be considered hermetically sealed (e.g., as indicated by calcium dot 958 retaining its reflective, metallic appearance and remaining free or substantially free of an opaque, white, flaky reaction product resulting from exposure to water and/or oxygen) after placing calcium patch test structure 900 in a chamber at 85° C. and 85% relative humidity for 1000 hours.

In some embodiments, another calcium patch test structure can be formed on bonding structure 600 (e.g., as shown in FIGS. 6A-6B). For example, a layer of calcium can be evaporated to form calcium patches on spacings 611 between patterned gaps of bonding structure 600 before bonding top substrate 660 and bottom substrate 620. The layer of calcium can have a thickness in a range from about 80 nm to about 120 nm. Bonding structure 600 with calcium patches between patterns 601-609 can be transferred to a laser weld station to bond top substrate 660 to bottom substrate 620 across patterned gaps 654. The calcium patches can be hermetically sealed by horizontal bond tracks along the x-axis above and below patterns 601-609 and vertical bond tracks along the y axis across patterns 601-609. Bonding structure 600 with calcium patches between patterned gaps can pass hermeticity testing at 85° C. and 85% relative humidity for 1000 hours as described herein.

Exemplary Method to Form a Bonded Structure with Patterned Gaps

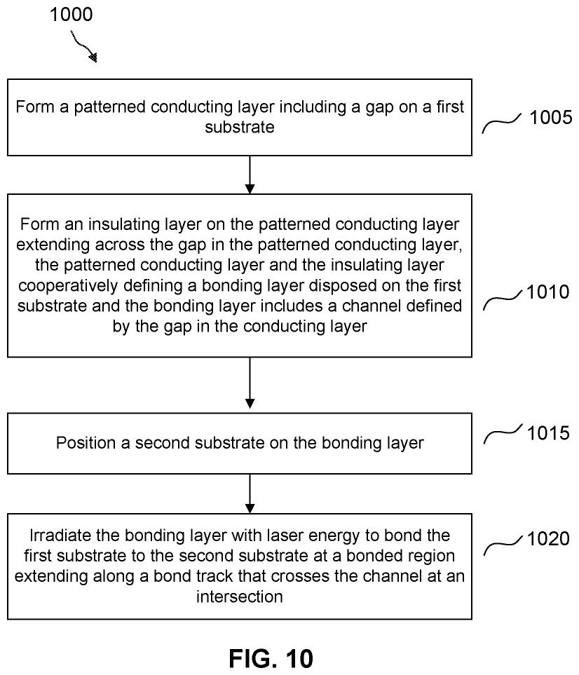

FIG. 10 shows a flowchart depicting a method 1000 for forming a bonded structure with patterned gaps, according to some embodiments. This disclosure is not limited to this operational description. It is to be appreciated that additional operations may be performed. Moreover, not all operations may be included in all embodiments of the disclosure provided herein. Further, some of the operations may be performed simultaneously, or in a different order than shown in FIG. 10. In some embodiments, operations of method 1000 can be performed on, for example, bonding structure 600 of FIG. 6. Operations of method 1000 can also be performed by other embodiments included in this disclosure. In some implementations, one or more other operations may be performed in addition to or in place of the presently described operations.

In some embodiments, method 1000 starts with operation 1005 by forming a patterned conducting layer including a gap on a first substrate. For example, referring to FIG. 6B, conducting layer 628 can be formed on bottom substrate 620. Conducting layer 628 can include patterned gap 654 formed in conducting layer 628.

In some embodiments, operation 1010 comprises forming a capping layer on the patterned conducting layer. The capping layer can extend across the gap in the patterned conducting layer. The patterned conducting layer and the capping layer can cooperatively define a bonding layer (e.g., a patterned bonding layer comprising the patterned gap or channel) disposed on the first substrate. The bonding layer can include a channel defined by the gap in the conducting layer. For example, referring to FIG. 6B, capping layer 632 can be formed on patterned conducting layer 628. Capping layer 632 can extend across patterned gap 654 in conducting layer 628. Patterned conducting layer 628 and capping layer 632 can cooperatively define bonding layer 640 disposed on bottom substrate 620. Bonding layer 640 can include a channel defined by patterned gap 654 in conducting layer 628, as shown in patterns 601-609 in FIG. 6A.

In some embodiments, operation 1015 comprises positioning a second substrate on the bonding layer. For example, referring to FIG. 6B, top substrate 660 can be positioned on bonding layer 640.

In some embodiments, operation 1020 comprises irradiating the bonding layer with laser energy (e.g., by directing the bonding laser through the first substrate or the second substrate to impinge on the bonding layer) to bond the first substrate to the second substrate at a bonded region extending along a bond track that crosses the channel at an intersection. The bonded region can be substantially continuous across the intersection. The substantially continuous bonded region can be free of voids. For example, referring to FIG. 7A, bonding layer 740A can bond top substrate 760A and bottom substrate 720A at bonded region 756A. Referring to FIG. 8, bonded region 856 can extend along bond track 858 that crosses the channel at an intersection. Referring back to FIG. 7A, bonded region 756A can be substantially continuous across the intersection and free of voids.

It is to be understood that the phraseology or terminology herein is for the purpose of description and not of limitation, such that the terminology or phraseology of the present specification is to be interpreted by those skilled in relevant art(s) in light of the teachings herein.

The above examples are illustrative, but not limiting, of the embodiments of this disclosure. Other suitable modifications and adaptations of the variety of conditions and parameters normally encountered in the field, and which would be apparent to those skilled in the relevant art(s), are within the spirit and scope of the disclosure.

While specific embodiments of the disclosure have been described above, it will be appreciated that the disclosure may be practiced otherwise than as described. The description is not intended to limit the disclosure.

It is to be appreciated that the Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein.

The breadth and scope of the present disclosure should not be limited by any of the above-described exemplary embodiments, but should be defined only in accordance with the following claims and their equivalents.

1. A bonded article comprising:
a first substrate;
a second substrate; and
a bonding layer disposed between the first substrate and the second substrate and comprising a conducting layer and a capping layer formed on the first substrate;
wherein the first substrate is bonded to the second substrate at a bonded region extending along a bond track;
wherein the bonded region is substantially continuous between the first substrate and the second substrate.

2. The bonded article of claim 1, wherein the bonded region seals a gap disposed between the first substrate and the second substrate and at least partially defined by a channel in the bonding layer.

3. The bonded article of claim 1, wherein the bonded region is substantially free of voids.

4. The bonded article of claim 1, wherein the capping layer of the bonding layer is at least partially dispersed into at least one of the first substrate or the second substrate in the bonded region.

5. The bonded article of claim 1, wherein each of the conducting layer and the capping layer of the bonding layer is at least partially dispersed into at least one of the first substrate or the second substrate in the bonded region.

6. The bonded article of claim 1, wherein the bonding layer is conductive across the bonded region.

7. The bonded article of claim 1, wherein a resistance of the bonding layer across the bonded region is less than or equal to about 10 kΩ.

8. The bonded article of claim 1, wherein:
the conducting layer has a thickness of about 100 nm to about 200 nm; and
the capping layer has a thickness of about 25 nm to about 75 nm.

9. The bonded article of claim 1, wherein:
the conducting layer comprises a metal material; and
the capping layer comprises a metal oxide material.

10. The bonded article of claim 9, wherein:
the metal material of the conducting layer is chromium, nickel, gold, silver, aluminum, tungsten, cobalt, iron, titanium, molybdenum, or a combination thereof; and
the metal oxide material of the capping layer is chromium oxynitride.

11. The bonded article of claim 1, comprising a channel formed in the bonding layer, wherein the capping layer extends across the channel formed in the bonding layer, and the bond track crosses the channel in the bonding layer at an intersection.

12. The bonded article of claim 11, wherein the bonding layer is non-conductive across the channel.

13. The bonded article of claim 12, wherein a resistance of the bonding layer across the channel is greater than or equal to about 10 MΩ.

14. The bonded article of claim 11, wherein the channel formed in the bonding layer has a width of about 0.5 μm to about 20 μm.

15. A method comprising:
forming a patterned conducting layer on a first substrate, the patterned conducting layer comprising a gap formed therein;
forming a capping layer on the patterned conducting layer, the capping layer extending across the gap in the patterned conducting layer, the patterned conducting layer and the capping layer cooperatively defining a bonding layer disposed on the first substrate, the bonding layer comprising a channel defined by the gap in the conducting layer;
positioning a second substrate on the bonding layer; and
irradiating the bonding layer with laser energy to bond the first substrate to the second substrate at a bonded region extending along a bond track that crosses the channel at an intersection;
wherein the bonded region is substantially continuous across the intersection.

16. The method of claim 15, comprising forming the patterned conducting layer comprising the gap having a width of about 0.5 μm to about 20 μm.

17. The method of claim 15, wherein:
the patterned conducting layer has a thickness of about 100 nm to about 200 nm; and
the capping layer has a thickness of about 25 nm to about 75 nm.

18. The method of claim 15, wherein:
the patterned conducting layer comprises a metal material; and
the capping layer comprises a metal oxide material.

19. The method of claim 15, wherein the irradiating the bonding layer with the laser energy comprises setting a pulse energy, a focus, a marking speed, or a combination thereof of a pulsed laser.

20. The method of claim 15, wherein the irradiating the bonding layer with the laser energy comprises setting a power density, an exposure time, or a combination thereof of a continuous wave laser.
